(19) United States
(12) Patent Application Publication
(10) Pub. No.: US 2021/0116159 A1
(43) Pub. Date: Apr. 22, 2021

(54) A HYBRID HEAT PUMP

(71) Applicant: Michael Robin Bolwell, Yaxley, Peterborough (GB)

(72) Inventor: Michael Robin Bolwell, Yaxley, Peterborough (GB)

(21) Appl. No.: 17/044,786

(22) PCT Filed: Mar. 22, 2019
(86) PCT No.: PCT/GB2019/050831

§ 371 Date: Oct. 1, 2020

(30) Foreign Application Priority Data
Apr. 2, 2018 (GB) 1805409.8
Jun. 22, 2018 (GB) 1810323.4

(51) Int. Cl. F25B 49/02; F25B 13/00; F25B 30/02; F25B 31/02

(52) U.S. Cl. CPC F25B 49/02; F25B 31/026; F25B 30/02; F25B 13/00

(57) ABSTRACT

The present invention relates to an electrically driven, vapour compression heat pump device. The heat pump device comprises a variable speed or variable capacity refrigerant compressor, a compression stage having a first condenser, an expansion stage having a first evaporator, a DC to AC variable speed compressor drive inverter unit, a grid AC to DC power supply unit and an electronic control unit. The control unit varies the thermal capacity, and the power consumed by the device, in response to an input from at least one of: a renewable electricity generation input, a premises net consumption monitor, a utility grid frequency monitor, and a third party control input.

### FIELD OF THE INVENTION

The present invention relates to heat pumps, and in particular vapour compression type heat pumps typically used for space heating/cooling, and/or water heating applications.

### BACKGROUND OF THE INVENTION

Vapour compression type heat pumps are typically classified as either air source heat pumps or ground source heat pumps, according to where the thermal output is sourced from. Their increasing use in commercial and domestic properties is driven by concerns regarding carbon dioxide emissions, the cost of energy, and energy security.

Conventionally, air source heat pumps are a low cost and simple-to-install renewable heat option. Their main drawback is that both heat output and efficiency decrease with decreasing ambient air temperature, which is when the requirement for heat is greatest. Common solutions to this are to deliberately oversize the pump capacity or to have a backup fossil fuel heating system. However, these solutions may increase capital cost, running costs, and CO2 emissions.

Ground source, or ground coupled, heat pumps avoid this drawback as the thermal mass of the ground provides a stable source temperature for the pump. Thus, the performance of a ground coupled heat pump is relatively unaffected by weather conditions. However, the cost and disruption of installing the ground loop are significant, and this prevents widespread adoption of ground coupled heat pump systems.

There is also a potential issue regarding the increased load on the electrical grid that would result from a widespread transition from natural gas fired heating to electrically driven heat pumps. This comes on top of the increasing use of electricity for personal transportation. It is possible to use an electrical battery to facilitate the use of low rate or renewably generated electricity by the heat pump, but this form of electrical storage is expensive.

### SUMMARY OF THE INVENTION

According to a first aspect of the invention there is provided an electrically driven, vapour compression heat pump device comprising: a variable speed or variable capacity refrigerant compressor, a compression stage having a first condenser, an expansion stage having a first evaporator, a DC to AC variable speed compressor drive inverter unit, a grid AC to DC power supply unit and an electronic control unit, the control unit varying the thermal capacity, and the power consumed by the device, in response to an input from at least one of: a renewable electricity generation input, a premises net consumption monitor, a utility grid frequency monitor, and a third party control input.

The control unit may vary the thermal capacity, and the power consumed by the device, in response to an input from a user interface and/or one or more temperature sensing elements in addition to the input from at least one of: a renewable electricity generation input, a premises net consumption monitor, a utility grid frequency monitor, and a third-party control input.

The thermal capacity, and the power consumed by the heat pump device, may be varied through modulation of the compressor speed and/or the compressor capacity.

The heat pump device may further comprise at least one of: an electronic or electrochemical charge storage unit. The electronic or electrochemical charge storage unit may comprise one or more supercapacitors.

The heat pump device may further comprise a DC input connector for receiving power from a renewable energy source. The heat pump device may further comprise a DC connector for an external rechargeable battery. The heat pump device may further comprise an integral rechargeable battery. The heat pump device may further comprise a DC output connector for supplying power to an external DC to AC grid tie inverter. The heat pump device may further comprise an integral DC to AC grid tie inverter.

The heat pump device may further comprise an electrically braked positive displacement expander. The electrically braked positive displacement expander may be a scroll expander that is mechanically coupled to a generator.

The heat pump device may further comprise an automatically adjustable refrigerant restrictive orifice that is controlled by the electronic control unit. The automatically adjustable refrigerant restrictive orifice may be an electrically adjustable expansion valve.

The heat pump device may further comprise an electrically operated refrigerant fluid reversing valve, configured so as to cause the expansion and compression stages of the device and the roles of condenser and evaporator to swap, one to the other.

The heat pump device may further comprise a second evaporator, the second evaporator being a brine and/or glycol coupled evaporator within the expansion stage, the first evaporator being air coupled, the first condenser being water coupled. The second evaporator may be series connected to the first evaporator such that the refrigerant fluid passes through the first evaporator first.

The heat pump device may further comprise a second condenser within the compression stage, the second condenser being an air coupled condenser. The second condenser may be series connected to the first condenser such that the refrigerant fluid passes through the first condenser first.

The heat pump device may further comprise, in combination, an additional condenser, the additional condenser being water coupled, and a refrigerant circuit reversing valve, the position of the reversing valve in the refrigerant circuit preserving the role of the additional condenser, while allowing the function of evaporator and condenser in the first and second evaporators, the first condenser and where fitted, the second condenser to be switched by the reversing valve.

According to a second aspect of the invention there is provided a method of operation of a heat pump device, the method comprising controlling the heat pump device to vary the AC power generated and/or consumed by the heat pump device in response to a change in the utility grid frequency in order that the heat pump device provides a dynamic frequency response service to the utility grid.

The change in the utility grid frequency may be any change and/or ongoing changes in the utility grid frequency.

The heat pump device may be configured to only use a direct current renewable electricity input to operate and to modulate the compressor speed and the thermal capacity of the heat pump device according to the amount of renewable generation available.

The heat pump device may be controlled to match the power demand of the premises to the available renewable power generation by variation of the AC power generated or consumed by the heat pump device, in order to minimise the units of power either imported from or exported to the grid.

An excess of renewable power generation surplus to the electrical consumption of the premises may be used to power the heat pump device in order to heat the ground via a ground coupled element, using heat derived from the air coupled evaporator.

The grid AC to DC power supply unit may provide power to the compressor drive inverter unit and control unit while also providing a charging function to at least one of an electronic charge storage unit and a rechargeable battery.

The heat pump device may be able to vary its heat pumping capacity in response to changes in the net building load and any other power or control inputs, independently of the operating pressures and temperatures of the expansion and compression stages. This may allow the coefficient of performance of the heat pump device to be maximised for any given source and sink temperatures, any compressor speed, and any power consumption of the heat pump device demanded by the control unit.

The capacity responsive aspect of the heat pump device may be applied to both heating and cooling operating modes of the heat pump device.

The first condenser may reject heat to a water sink.

The heat pump device may have a mode of operation whereby it can utilise surplus renewable electricity generation to thermally pre-charge a ground coupled element using ambient air source heat. Where a hybrid solar PV-T system is installed, any surplus solar thermal output can also be added to the heat delivered to the ground coupled element.

The addition of a second evaporator to the heat pump device may provide the heat pump with the capability to pump and store heat from an ambient air source to a ground thermal coupling on warm, sunny days and subsequently recover the stored heat from the ground coupling for winter heating, when the heat pump device is suitably installed as part of a hydronic renewable heat system.

According to a third aspect of the invention, the heat pump device may comprise an electrically driven, variable speed compressor, a compression stage having a first condenser rejecting heat to a water sink, a series connected expansion stage having a first evaporator absorbing heat from an ambient air source and a second evaporator absorbing heat from a brine source, a DC to AC variable speed compressor drive inverter unit, a grid AC to DC power unit, an electronic charge storage unit, a DC input connection for receiving power from a renewable energy source, a DC connection point for a rechargeable battery, an integral DC to AC grid tie inverter and an electronic power control unit, the power control unit modulating the thermal throughput and power consumed by the device in response to inputs from one or more temperature sensors, a renewable electricity source, a premises net consumption monitor, a user interface and a third party control input.

The electronic control unit of the heat pump device may determine the compressor speed by frequency and voltage control of a three-phase power output of the compressor drive unit and may also determine the power output of at least one of: the AC to DC power unit, a utility grid tied inverter unit, a solar photo-voltaic source and one or more DC to DC converters.

The electronic control unit of the heat pump device may receive an input from at least one of: one or more temperature sensors, a user interface, a programmable timer interface, a current transformer or power monitoring device attached to the incoming electric utility supply to the premises in which the device operates, a signalling input from a utility company and an external, internet connected, smart control unit.

The compressor drive inverter unit may receive DC power from at least one of: a line AC to DC battery charging unit, a renewable energy electrical source, an electronic charge storage unit and a rechargeable battery.

The DC to AC grid tie inverter may receive DC power from at least one of: a renewable energy electrical source, an electronic charge storage unit and a rechargeable battery.

The current transformer input to the heat pump device may operate in conjunction with the electronic control unit such that the magnitude of current and/or the units of power exported to or imported from the utility grid may be reduced to the minimum possible for a given mean heating or cooling requirement, solar PV input and battery capacity.

Where the heat pump device uses a renewable electricity generation of DC power on the premises, such as a solar photovoltaic installation or a wind or water turbine, the losses incurred in both the renewable system grid tie inverter and the rectifier within an inverter type heat pump may be avoided by directly connecting the renewable electricity source to the heat pump of the device via a DC input connector. Any renewable generation in excess of the electrical consumption of the device may be relayed to an existing grid tie inverter on the premises via a DC output connector on the device or converted to line AC by a grid tie inverter within the device. As the compressor drive unit takes priority on the solar PV power, this may reduce the loading on the grid tie inverter, which tends to operate closer to its peak operating efficiency, and more often, as a result.

In a typical grid tie solar PV installation there are typically significant changes in the direction and amount of power imported from or exported to the grid on a second by second basis as thermostatically controlled heating loads are cycled and as cloud formations interrupt the level of insolation. According to the present disclosure, the electronic charge storage unit acts as a buffer between these rapidly changing power transients in the absence of a rechargeable battery, and the longer time interval required by the compressor of the device to change its speed and power consumption.

The thermal capacity of a water tank and the thermal inertia inherent in a building may be utilised in the way an electrically rechargeable battery would, allowing a load limiting and load shifting capacity of some hours to be provided by control and modulation of the heat pump compressor in relation to Demand Side Management signalling and the magnitude and direction of power passing through the electric utility meter of the premises served by the heat pump. This is especially true where the heat pump is connected to an under floor heating system. Both the cost of, and the space taken by, an electrical battery can be reduced or eliminated by substitution with the thermal storage capacity already present in a building.

The control unit may act on, or anticipate, changing weather conditions and changes to the electrical unit time of day pricing and adjust the target temperature of the controlled environment accordingly. This may lower the overall cost of the heat pump operation while keeping the degree of temperature variation within acceptable comfort limits.

The control unit may regulate the PV input voltage to a level that extracts the highest output from the PV input at any given operating condition. This may provide a maximum power point tracking facility for the PV installation.

The charge storage unit of the heat pump device may comprise one or more supercapacitors.

The heat pump device may also comprise both a first condenser and a second condenser within the compression stage, the first condenser rejecting heat to a liquid sink, such as water and the second condenser rejecting heat to an air sink, the first condenser and the second condenser being connected in series, with the refrigerant fluid passing through the first condenser first. In other embodiments it is anticipated that the first condenser and the second condenser need not be connected in series.

The addition of a second condenser of the fan coil type may allow the heat pump to deliver space heating and hot water to an existing hydronic central heating system by means of the first condenser, while providing additional space heating by means of the second condenser. This may avoid the need to increase the size of the heat emitters of existing hydronic systems to compensate for the lower heat delivery temperature of a heat pump compared to a combustion water heater. Furthermore, if the refrigerant cycle is reversed, the second condenser is more effective in providing a cooling function than a flat panel heat emitter. In this operating mode, the second condenser becomes a first evaporator in the refrigerant circuit.

The heat pump device may further comprise both an additional de-superheat condenser and a refrigerant circuit reversing valve, the additional de-superheat condenser capable of rejecting heat to a water sink, the position of the reversing valve in the refrigerant circuit preserving the role of the additional de-superheat condenser, while allowing the function of the first and/or second evaporator and the first and/or second condenser to be swapped by the reversing valve.

The heat pump device may have a mode of operation, such that it has priority use of a direct current renewable electricity input, any renewable generation surplus to the electrical consumption of the device being made available for use within the premises or for export to the grid by a grid tie inverter.

The heat pump device may have a mode of operation whereby the device will only use a direct current renewable electricity input to operate and is configured to modulate the compressor speed and thermal throughput according to the amount of renewable generation available. This mode of operation may ensure the lowest operating cost and zero cooling load on the electrical grid, particularly when the heat pump device is providing a cooling function in summer.

The heat pump device may have a mode of operation, such that the premises in which the device operates has priority use of the direct current renewable energy input to the device, the power control unit of the device seeking to match the power demand of the premises to the available renewable power generation by variation of the AC power generated and DC power consumed by the device, in order to minimise the units of power either imported from or exported to the grid. Any imbalance between the renewable generation and the combined load of the device and the premises is absorbed or delivered by at least one of; a charge storage unit and a rechargeable battery. In this mode of operation, the electrical load control may be of equal or higher priority than the temperature control of the premises.

The heat pump device may have a mode of operation, such that an excess of renewable power generation surplus to the electrical consumption of the premises is used to power the device in order to thermally pre-charge the ground via the ground coupled element using heat derived from the air source evaporator. This mode of operation may provide a method of converting renewable electricity generation that cannot be economically stored or exported to be converted to long term, inter-seasonal thermal storage.

### BRIEF DESCRIPTION OF THE DRAWINGS

Practicable embodiments of the invention will now be described in further detail, with reference to the accompanying drawings, of which:

FIG. 1 is a block diagram of the electronic modules within a device;

FIG. 2 is an refrigerant circuit diagram of a vapour compression dual source heat pump within the device;

FIG. 3 is a circuit diagram of an alternative refrigeration gas circuit of FIG. 2;

FIG. 4 is an alternative refrigerant circuit diagram of a vapour compression dual source heat pump within the device;

FIG. 5 is the alternative refrigerant circuit diagram of FIG. 4, additionally comprising a split point;

FIG. 6 is a diagram of an example hybrid renewable heating system using the circuit of FIG. 4; and

FIG. 7 is a system diagram of the dual source heat pump of FIG. 6.

### DETAILED DESCRIPTION OF THE DRAWINGS

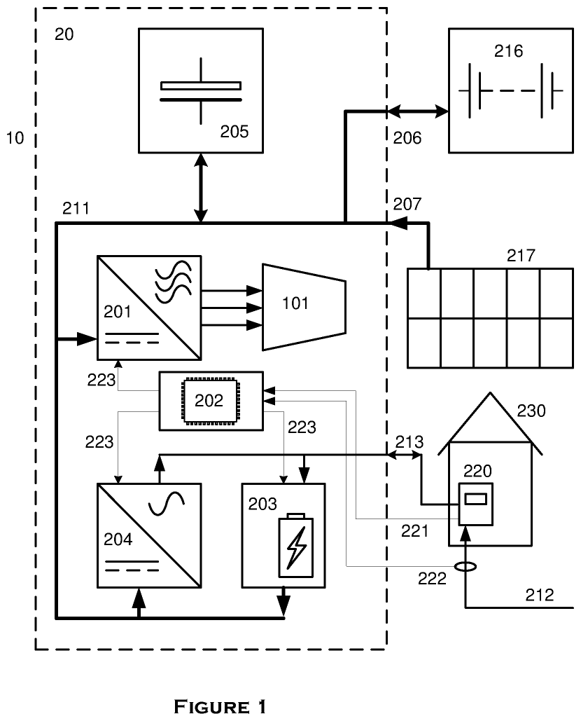

FIG. 1 shows a block diagram of the main electrical and electronic module 20 within a heat pump device 10. There is a DC bus 211 that is connected to a charge storage unit 205, a compressor drive inverter unit 201, an electrically driven 3 phase compressor 101, a DC to AC grid tie inverter unit 204 and an AC to DC power supply unit 203. There is also a DC electrical connection point 206 for a rechargeable battery 216, a DC input connection point 207 for a renewable energy input 217, such as solar photovoltaic (PV) panels, and a utility mains connection 213 to the device 10. There is also a compressor 101, a control unit 202 with control outputs 223 and a net power monitor 222. The net power monitor 222 is coupled to the incoming supply 212 to the utility meter 220 within the premises 230 where the device 10 is installed. There is also a signalling input 221 from a utility company or a third party to the control unit.

The control unit 202 is able to monitor inputs from a net power monitor, such as a current transformer 222 attached to the incoming utility supply line 212, temperature sensors (not shown), the state of charge of the battery 216, the amount of renewable energy input 207 and a third-party signal 221. The outputs of the control unit 202 determine the amount of power consumed by the compressor inverter drive 201 and the power supply 203, or the amount of power delivered by the grid tie inverter 204.

When the device 10 is in stand-alone mode with no renewable input 217 or battery 216 connected, the device 10 can bias its operating hours to take advantage of low rate electricity and avoid the use of peak rate power. The device 10 can also reduce or eliminate its power consumption at times of high power consumption elsewhere within the premises 230 through monitoring of the current transformer 222 and instead, operate during periods of lower load, within a window of acceptable temperature control. This is of benefit where the utility company levies a charge in relation to the peak current demand of the premises.

When a DC input 207 from a photovoltaic or renewable energy system 217 is provided, there is an efficiency gain through direct connection to the DC bus 211 that also connects the super capacitor bank 205, the compressor inverter drive 201, the grid tie inverter 204, the power supply 203 and an optional battery 216 via connector 206. This avoids the losses that normally occur in converting the DC renewable input 207 to grid AC and then back to DC for the compressor inverter 201. The controller 202 can also seek to zero the net power flow in the utility grid connection 212, reducing both the amount of renewable power exported and the total grid power consumed, by control of the grid tie inverter 204 and power supply 203 and thereby, control of the magnitude and direction of power in the AC power connection 213 to the unit 10. This is achieved by varying the power generated by the grid tie inverter 204, or the power consumed by the power supply 203, in order to balance the total load of the premises 230 against the renewable power generation at any instant.

The supercapacitor bank 205 allows the grid tie inverter 204 and power supply 203 to respond swiftly to changes in the total premises consumption and solar input, while allowing more gradual changes in the compressor 101 speed and the thermal output of the device 10. This allows the device 10 to provide some of the load levelling capability that a rechargeable battery would provide, but by combining the short term electrical capacity of the charge storage device with the longer term thermal capacity of the building. The addition of a rechargeable battery 216 enhances the energy storage as the stored electrical energy can be used throughout the premises and can permit extended operation of the device on renewable power, allowing a greater reduction in the building net power flows. In this configuration, the power supply 203 will also act as a charger for the battery 216. The battery 216 and renewable input 217 also allow the device 10 to operate during a grid outage.

The grid tie inverter 204 operates whenever there is surplus PV generation or whenever it is economically beneficial to transfer energy from the super capacitor 205 or the battery 216 to the grid 212. The DC power unit 203 operates whenever there is insufficient renewable energy input to drive the compressor 101 or whenever it is beneficial to charge the battery 216 or supercapacitor 205 from the grid 212. The control unit 202 ensures that the grid tied inverter 204 and DC power unit 203 never operate simultaneously. The control unit 202 also determines the operation of the ancillary components within the device 10, such as circulation pumps, motorised valves and electrical relays.

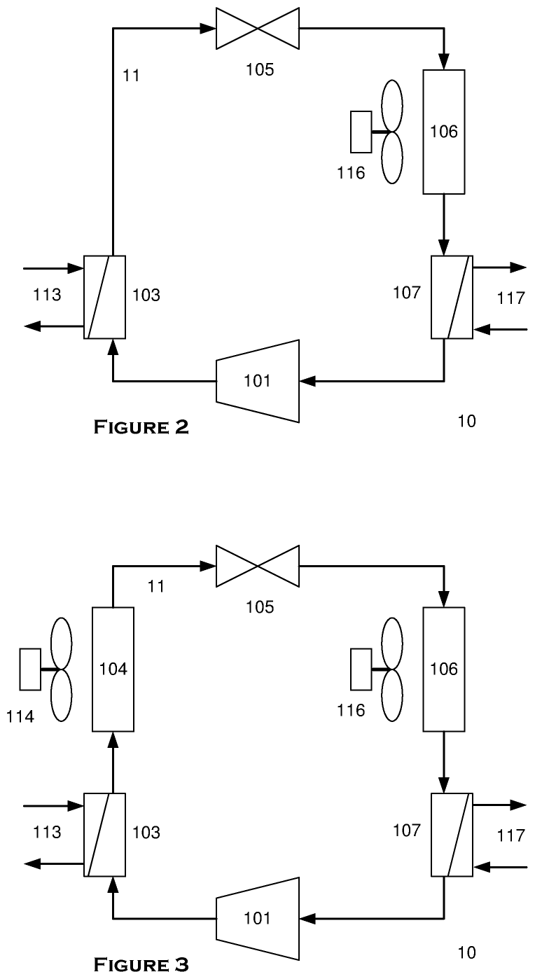

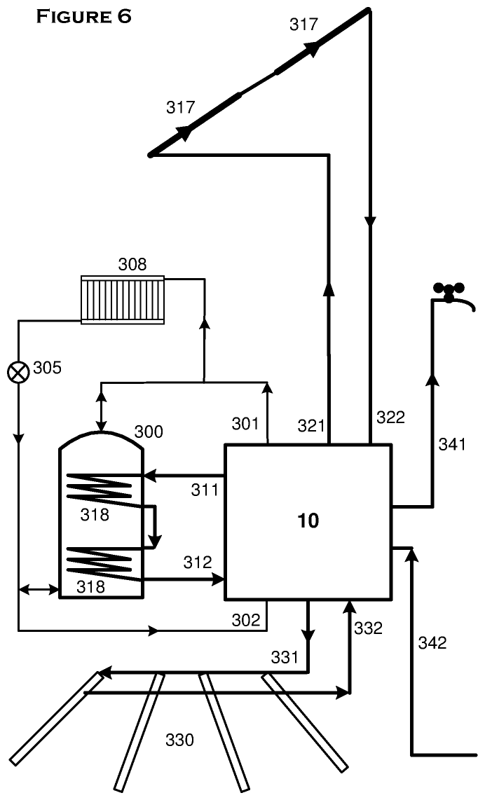

FIG. 2 illustrates the closed loop refrigerant circuit 11 of the dual source heat pump device 10 of FIG. 1. The refrigerant circuit 11 and the direction of the refrigerant flow are indicated by the arrows. The refrigerant fluid flow is in a clockwise direction. The circuit comprises the compressor 101, a water coupled condenser 103 with hydronic connections 113 to a buffer tank (FIG. 6, 300), an expansion valve 105, an external air coupled evaporator 106 with fan 116, and a brine coupled evaporator 107 with hydronic connections 117 to a ground loop (FIG. 6, 330).

Starting from the compressor 101, the hot compressed refrigerant gas passes through a first water coupled condenser 103 where the refrigerant loses heat to a hydronic circuit 113, which in turn conveys the heat to a buffer tank and a wet heating system. The condensed refrigerant fluid then passes through an expansion valve 105, to a first air coupled evaporator 106, then to a second liquid coupled evaporator 107. A fan 116 provides externally sourced air to the evaporator 106. Any liquid refrigerant emerging from the first evaporator 106 is vaporised in the second evaporator 107 by heat drawn from a hydronic circuit 117. Preferably, brine or glycol is used as the heat transfer fluid and is used to deliver heat from a ground source, a solar thermal source, or both a solar and ground source.

In this embodiment, the evaporator 106 and fan 116 give the heat source priority to an external air source over the ground source 107, reserving the use of ground source heat for the coldest weather only, and allowing a shorter ground loop to be used. When the external air temperature is too low to be of benefit, the fan 116 may be switched off. The fan 116 may also draw air from a plant room or exhaust air from a mechanical heat recovery unit.

The dual source capability of the device 10 allows the controller 202 to utilise a surplus renewable electricity source to pump heat from an air source to a ground loop, via a buffer tank (FIG. 6, 300). The stored heat may subsequently be used directly for under floor heating, or may be recovered from the ground loop by the device 10, as much as months later. This feature is of particular benefit where the financial benefit of exporting surplus renewable generation is low or not applicable

FIG. 3 shows the refrigerant circuit 11 of FIG. 2, but with a second air coupled condenser 104 and a fan 114 passing internal air over the condenser 104. The condenser 104 may be an optional fan coil unit and is installed in the refrigerant circuit 11 between the first water coupled condenser 103 and the expansion valve 105. Although not required, the indoor fan coil unit 104, 114 allows extra heat to be provided to the room in which it is installed, which can be beneficial in very cold weather, or if the existing radiator system delivers insufficient heat due to the lower flow temperature typical of heat pumps. It also aids in the provision of room cooling in summer if the refrigerant cycle is reversed. The liquid cooled condenser 103 has priority on the heat from the refrigerant. This allows the domestic hot water tank and radiator system to have priority over the indoor fan coil unit 104 when fitted.

However, if rapid heating of the room containing the fan coil unit 104, 114 is required, this may be achieved by delaying the operation of the water pump on the hydronic circuit 113. It will be apparent to the skilled person that if the refrigerant flow is in an anti-clockwise direction, then both the order and the role of the evaporators 106, 107 and the condensers 103, 104 are swapped. The terms “first” and “second” refer to the heat exchanger priorities as well as the order of the heat exchangers relative to the refrigerant flow.

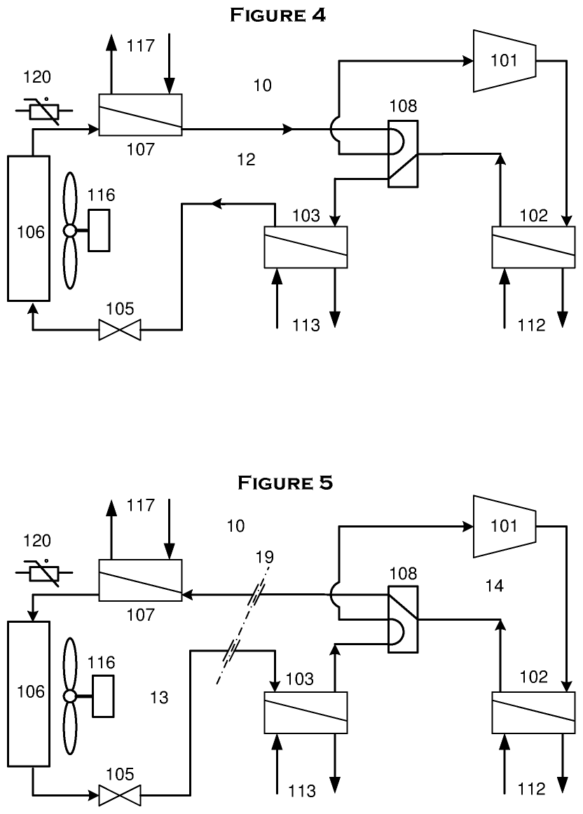

FIG. 4 shows an alternative vapour compression heat pump circuit 12 within the device 10. In addition, there is shown a liquid cooled condensing heat exchanger 102 with hydronic connections 112 for a sanitary hot water tank (not shown), a refrigerant reversing valve 108 and a thermostatic switch or temperature sensor 120 in thermal contact with the refrigerant pipe that connects the evaporators 106 and 107. The refrigerant fluid and hydronic flows are as indicated by the arrows.

The hot refrigerant discharge from the compressor 101 passes to an additional sanitary water coupled de-superheat condenser 102, where superheated refrigerant and some latent heat is used to heat a small sanitary water tank, either by incorporating the heat exchanger 102 within the tank, or via fluid unions 112. This provides quick heating, and to a higher temperature than the refrigerant condensation temperature alone would permit. The refrigerant then passes through a reversing valve 108, then to a second water coupled condenser 103, where its remaining latent heat is given up to a central heating buffer tank via fluid unions 113. The refrigerant then passes through expansion valve 105 before passing through a first air coupled evaporator 106 with a fan 116, taking whatever heat is available from the external ambient air. Any further heat required for full refrigerant evaporation is taken from a brine or glycol coupled evaporator 107, and a ground and solar thermal loop connected to unions 117. The refrigerant returns to the compressor 101 via reversing valve 108. A thermostat or temperature sender 120 is thermally coupled to the refrigerant pipe linking the two evaporators 106 and 107 and can be used to control a ground and solar loop circulation pump. The components of the device illustrated in FIG. 4 are within an enclosure known in the art as a monoblock unit.

FIG. 5 shows the refrigerant circuit of FIG. 4 as split circuits 13 and 14, with one possible split point indicated by the broken line 19. The gas circuit 14 to the right of the split line is located indoors and the gas circuit 12 is located outdoors. The reversing valve 108 is shown in its alternative position (relative to its position in FIG. 4) and so the roles of condenser and evaporator are reversed for the heat exchangers 106, 107 and 103. Heat exchanger 102 still retains its role as a sanitary water de-superheat condenser due to it being located between the gas discharge of the compressor 101 and the reversing valve 108. Any remaining heat is given up to the brine coupled condenser 107 and the ground loop connected to unions 117 for long term storage. In this mode, the air coupled condenser 106 has little heat to dissipate, due to the reversed refrigerant flow. This allows the fan 116 to be slowed or switched off to save energy. In this mode, the buffer tank connected to unions 113 becomes a store of cooling capacity.

FIG. 6 shows an example of a hybrid renewable heating or heat and energy system using the dual source heat pump circuit of FIG. 4. The device 10 is a monoblock unit and incorporates the refrigerant circuit 12 of FIG. 4.

The buffer tank 300 internal volume is connected to a wet heating system 308, a heating circulation pump 305 and also the device 10 by unions 301 and 302. The central heating circuit is indicated by the lighter lines. The primary heat collection circuit is indicated by the heavier lines and includes; —the buffer tank heat exchange coils 318 connected to the device 10 by unions 311 and 312; the solar collectors 317 connected to the device 10 by unions 321 and 322; and the ground loop 330 connected to the device 10 by unions 331 and 332. There is also a mains water supply 342 to the device 10 and a sanitary hot water outlet 341 from the device 10. The wet heating system encompasses the range of traditional wet heat emitters, such as under-floor heating, radiators or forced convection units.

The ground loop 330 is of a compact, multi loop storage format that can be installed without need of a large drilling rig and is better at conserving heat than the deep boreholes normally employed by ground loop systems Alternatively, the ground loop 330 may be a heat storage and sharing network. In this case, the heat produced by the device for storage is available for recovery during the heating season by all devices on the network, whether these are standard ground source heat pumps or dual source heat pumps. The benefit of converting surplus renewable electricity to stored heat is thus shared.

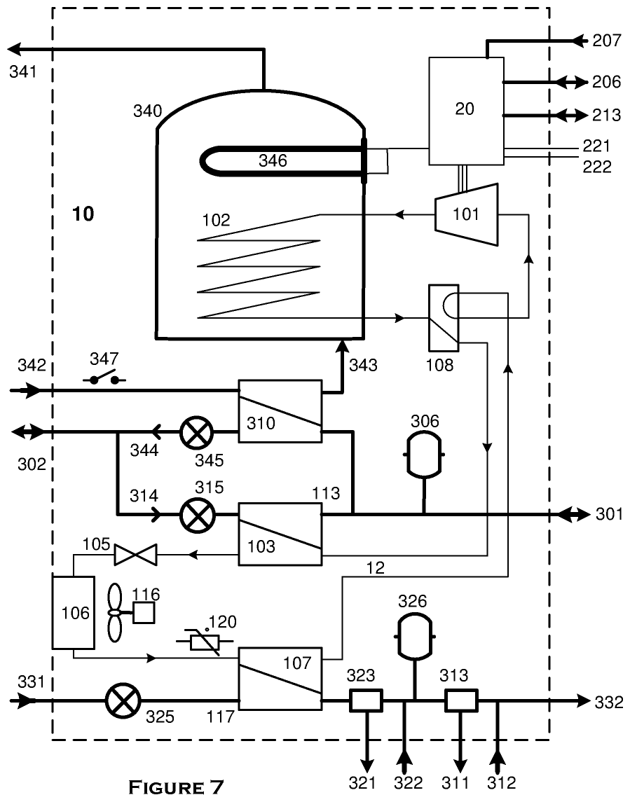

FIG. 7 shows a system diagram of the dual source heat pump 10 of FIG. 6. There is shown a sanitary hot water system comprised of a hot water outlet union 341, a cold-water inlet union 342, a sanitary water pre-heater 310, a pre-heated water inlet 343, a sanitary hot water tank 340, a refrigerant de-super heater 102, a backup resistance immersion heater 346 and a flow switch 347. There are central heating system unions 301 and 302 that connect to the top and base respectively of the buffer tank volume (300 of FIG. 5), these unions connect the buffer tank and heating system to the sanitary water pre-heater 310 via a pump 345 and check valve 344 and also to the refrigerant condenser 103 via unions 113, a pump 315 and check valve 314. An expansion vessel 306 accommodates expansion of the tank and central heating volume. There are also ground loop unions 331 and 332 that connect to the ground loop flow and return legs. Ground loop unions 331 and 332 are the brine circuit unions that connect to a pump 325, the refrigerant evaporator 107 via unions 117, motorised solar and ground loop bypass valves 323 and 313, the solar thermal collector flow and return unions 321 and 322, the buffer tank coil flow and return unions 311 and 312 and a brine system expansion vessel 326.

The refrigerant circuit 12 of FIG. 4 and the electronic module 20 of FIG. 1 are also shown, with the same component numbering applied. The electronic control unit 20 determines the operation of the pumps 315, 325, and 345, the diverter valves 313 and 323, the fan 116 and the immersion heating element 346. The flow switch 347 and the thermistor 120 are inputs to the control unit 20.

The solar collector bypass valve 323 operates at night, or when there is insufficient solar heat input, and prevents the stored ground heat 330 being radiated from the solar collector 317 by thermo-siphon action. The buffer tank bypass valve 313 operates whenever necessary to conserve the heat gained by the buffer tank 300, or to prevent it accepting further heat. The circulation pump 325 operates whenever heat transfer is required between any of the heat collection components. In the monoblock form of the device 10, designed for installation indoors, the external air may be supplied and removed from the air coupled evaporator 107 by ducting to an external wall.

The pump 345 operates when the flow switch 347 detects sanitary water flow, and thus pre-heats the cold-water supply 342 entering the sanitary water tank 340 using heat stored in the buffer tank. The check valve 314 prevents unwanted circulation through pump 315 when pump 345 operates. Similarly, the check valve 344 prevents circulation through pump 345 when pump 315 is in operation, to move heat from the condenser 103 to the buffer tank.

The dual source heat pump is designed to be the central component of a hybrid solar energy system that combines solar PV, solar thermal, air source and ground source heat, allowing synergies between the four systems to be realised. When combined with a solar PV-T system, at least some of the following discussed benefits may be realised.

The thermal output of a standard solar thermal system is restricted to the building hot water requirement in summer, in order to prevent overheating of the system. By combining solar thermal and ground source systems, the surplus thermal generation is absorbed by the ground loop to prevent overheating and also pre-charge the ground with heat. This allows a larger solar thermal collector to be installed that can also cover the hot water requirement in spring and autumn and contribute to space heating. The ground pre-charging raises the coefficient of performance of a ground source heat pump and may also allow a smaller capacity heat pump to be installed, reducing the installation cost.

In some embodiments, the PV collector 217 of FIG. 1 and the thermal collector 317 of FIG. 6 are the same. The electrical efficiency of a solar hybrid PV-T collector is slightly higher than that of a solar PV collector. When the thermal output is included, the overall efficiency is around three times that of a PV collector, making far better use of limited roof space. The electrical efficiency also benefits slightly from the water cooling of the PV cells. The electrical and thermal efficiencies of a PV-T panel are further enhanced by the heat pump providing active cooling of the glycol flow to the PV-T panels. This is especially true in colder weather.

The combination of ground thermal pre-charging and the contribution of solar thermal and air source heat allows the ground loop length to be reduced by as much as half the length of a conventional ground source heat pump system. The storage efficiency of the ground is enhanced by installing a network of much shorter loops of around 3 to 6 metres to give the total loop length required. This allows the loops to be installed using hand tools, resulting in a considerable cost saving. The compact form and ease of installation of the ground loop also allows properties that are on small plots to enjoy the benefits of ground source heating where there may be insufficient land area, or lack of drilling rig access, for a conventional ground source heating system.

The transition from air source to dual source or from dual source to ground source operation happens automatically, without the need for any form of control as the vaporising refrigerant only draws heat from the brine coupled evaporator 107 when insufficient heat is available from the outdoor air circulated through the evaporator 106. The ground loop brine or glycol circuit that transfers heat from the ground loop to the liquid based evaporator will have a circulation pump, as is normally fitted to ground source heating systems. To save energy, a thermostat may be fitted to the refrigerant pipe between the two evaporators and may be used to switch the circulation pump off when the ambient temperatures allow the air source evaporator to fully vaporise the refrigerant. Similarly, when the ambient air temperature is too low for air source heat to be effective, the fan 116 may be switched off to save energy, and to prevent the build-up of ice on the air coupled evaporator 106.

The dual source heat pump may be installed and operated in a similar way to a standard ground source heat pump, although the addition of one or more heat exchangers and one or more electronic modules will increase the purchase cost slightly. If a hybrid renewable energy system is desired but the installation budget doesn't allow for the installation of a PV-T collector or compact form ground loop installation, these components can be installed and connected to the dual source heat pump at a later date as and when finances allow.

Where an air source heat pump is used in its heating mode in warm weather, the heat pumps thermal output may be up to 4-5 times the electrical input and the refrigerant is entirely vaporised by air source heat. Where a dual source heat pump is used, the refrigerant gas in the glycol heat exchanger 107 of FIGS. 1, 3 and 4 will draw an insignificant amount of heat from the glycol, relative to the latent heat delivered to the buffer tank from the condenser 103. Thus, when valve 323 allows brine flow through the buffer tank coils 318, there is a substantial net flow of heat from the buffer tank 300 to the ground loop 330, providing long term storage of summertime air sourced heat for use in the winter. Further, the heat pump may be configured to only use surplus renewable electricity generation in this mode. Even when the thermal losses of the ground storage array 300 are accounted for, this can be a more cost-effective use of surplus renewable electric generation, compared to grid export.

The present invention provides a benefit in maximising the use of PV generation within the premises, by varying its power consumption in response to changes in PV generation and changes in the premises total electrical load as other appliances are used. This allows the invention to bring some of the benefits of a battery, without the cost of a battery. This is also of benefit to the electrical grid, as it reduces the maximum load on the grid, and also provides stability of load to the grid. The stability of the grid is further enhanced as the device is capable of soft starting, and may be controlled by the grid network operator. The transition from heating with gas to electrically driven heat pumps will inevitably occur as PV generation falls in price and fossil fuel becomes more expensive. This benefit of the present invention may mitigate the effects of this transition. If an optional battery is connected to the heat pump, these benefits may be amplified even further. The battery may be within an electrically powered vehicle, the rate of charging and discharging of the battery being controlled by the heat pump invention.

Preferably, the control unit of the device is able to change the mode of operation of the device in response to power measurement, signalling, control and temperature inputs and select an operating mode that assigns either first, second or third priority use of the renewable generation to each of the device, the premises in which the device operates, the recharging of the battery, and grid exportation, in response to the comfort or economy settings on the device. The device may also operate in either high output or high efficiency modes.

Further preferably, the device is able to use smart algorithms and machine learning to determine the most economical mode of operation in any given operating environment and setting.

By allowing the compressor speed to be influenced by the amount of renewable electricity generation, net building load or electricity unit price as well as thermal demand, the power used and thermal output of the device may be modulated in order to maximise the use of renewable electricity by the device or within the premises served by the device and minimise the use of utility power, particularly at times of high demand on the electricity grid or when electricity unit pricing is high. This harnesses the thermal inertia of the building fabric and any thermal storage within the premises to provide time shifting and levelling of the electrical load of the premises, thus providing a similar benefit to electro-chemical battery storage, but at a lower cost than a rechargeable battery. If the power supply to the compressor drive inverter is buffered by a charge storage unit, such as a bank of super capacitors, then the power consumption of the heat pump device can respond within milliseconds to changes in the net building load and any other power or control inputs while allowing a more gradual change in the compressor speed.

In developing the technical features of the heat pump device described herein, it has also become apparent that it may be possible to control the operation of various types of heat pump device such that the heat pump device varies the AC power generated and/or consumed in response to a change in the utility grid frequency, in order that the heat pump device provides a dynamic frequency response service to the utility grid so as to provide a grid frequency stability service. The heat pump device described above is particularly suitable for this purpose.

The dual source heat pump concept described in this patent allows for a high degree of flexibility in the method of implementation, installation, the configuration and the mode of operation of the invention. It will be appreciated by the skilled person that the present invention may take many alternative forms without deviating from the scope of this patent.

1.-24. (canceled)

25. An electrically driven, vapour compression heat pump device comprising; a variable speed or variable capacity refrigerant compressor, a compression stage having a first condenser, an expansion stage having a first evaporator, a DC to AC variable speed compressor drive inverter unit, a grid AC to DC power supply unit and an electronic control unit, the control unit varying the thermal capacity, and the power consumed by the device, in response to an input from at least one of: a renewable electricity generation input, a premises net consumption monitor, a utility grid frequency monitor, and a third party control input.

26. A heat pump device as claimed in claim 25, wherein the thermal capacity and the power consumed by the device are varied through modulation of the compressor speed and/or the compressor capacity.

27. A heat pump device as claimed in claim 25, further comprising at least one of: an electronic or electrochemical charge storage unit.

28. A heat pump device as claimed in claim 25, further comprising a DC input connector for receiving power from a renewable energy source.

29. A heat pump device as claimed in claim 25, further comprising a DC connector for an external rechargeable battery or an integral rechargeable battery.

30. A heat pump device as claimed in claim 25, further comprising a DC output connector for supplying power to an external DC to AC grid tie inverter or an integral DC to AC grid tie inverter.

31. A heat pump device as claimed in claim 25, further comprising an electrically braked positive displacement expander, the electrically braked positive displacement expander being a scroll expander that is mechanically coupled to a generator.

32. A heat pump device as claimed in claim 25, further comprising an automatically adjustable refrigerant restrictive orifice that is controlled by the electronic control unit, the automatically adjustable refrigerant restrictive orifice being an electrically adjustable expansion valve.

33. A heat pump device as claimed in claim 25, further comprising an electrically operated refrigerant fluid reversing valve, configured so as to cause the expansion and compression stages of the device and the roles of condenser and evaporator to swap, one to the other.

34. A heat pump device as claimed in claim 25, further comprising a second evaporator, the second evaporator being a brine and/or glycol coupled evaporator within the expansion stage, the first evaporator being air coupled, the first condenser being water coupled.

35. A heat pump device as claimed in claim 34, wherein the second evaporator is series connected to the first evaporator such that the refrigerant fluid passes through the first evaporator first.

36. A heat pump device as claimed in claim 27, wherein the electronic or electrochemical charge storage unit comprises one or more supercapacitors.

37. A heat pump device as claimed in claim 25, further comprising a second condenser within the compression stage, the second condenser being an air coupled condenser.

38. A heat pump device as claimed in claim 37, wherein the second condenser is series connected to the first condenser such that the refrigerant fluid passes through the first condenser first.

39. A heat pump device according to claim 25, further comprising in combination, an additional condenser, the additional condenser being water coupled, and a refrigerant circuit reversing valve, the position of the reversing valve in the refrigerant circuit preserving the role of the additional condenser, while allowing the function of evaporator and condenser in the first and second evaporators, the first condenser and where fitted, the second condenser to be switched by the reversing valve.

40. A method of operation of a heat pump device, the method comprising controlling the heat pump device to vary the AC power generated and/or consumed by the heat pump device in response to a change in the utility grid frequency in order that the heat pump device provides a dynamic frequency response service to the utility grid.

41. A method of operation according to claim 40, wherein the heat pump device is configured to only use a direct current renewable electricity input to operate and to modulate the compressor speed and the thermal capacity of the heat pump device according to the amount of renewable generation available.

42. A method of operation according to claim 40, wherein the heat pump device is controlled to match the power demand of the premises to the available renewable power generation by variation of the AC power generated or consumed by the heat pump device, in order to minimise the units of power either imported from or exported to the grid.

43. A method of operation according to claim 40, whereby an excess of renewable power generation surplus to the electrical consumption of the premises is used to power the heat pump device in order to heat the ground via a ground coupled element, using heat derived from the air coupled evaporator.

44. A method of operation according to claim 40 wherein the heat pump device is as defined in claim 25.
